(19) United States
(12) Patent Application Publication
(10) Pub. No.: US 2026/0092739 A1
(43) Pub. Date: Apr. 2, 2026

(54) OVEN

(71) Applicant: Illinois Tool Works Inc., Glenview, IL (US)

(72) Inventor: De WEI, Suzhou New District (CN)

(21) Appl. No.: 19/110,334

(22) PCT Filed: Jul. 28, 2023
(86) PCT No.: PCT/US2023/071260

§ 371 Date: Mar. 10, 2025

(30) Foreign Application Priority Data
Sep. 29, 2022 (CN) 202222597876.1

(51) Int. Cl. F27B 9/32; F27B 9/02; F27B 9/04

(52) U.S. Cl. CPC F27B 9/32; F27B 9/028; F27B 9/047

(57) ABSTRACT

The present application discloses an oven that comprises a lower housing assembly, an upper housing assembly, and a retaining assembly. The upper housing assembly is disposed above the lower housing assembly, the upper housing assembly is capable of opening and closing relative to the lower housing assembly and is capable of forming a working cavity when closed with the lower housing assembly, the upper housing assembly comprises an upper housing front plate. The retaining assembly is fixedly disposed on the upper housing front plate to prevent substantial deformation of the upper housing assembly during heating.

### RELATED APPLICATIONS

This international application claims priority to Chinese Patent Application No. 202222597876.1, filed Sep. 29, 2022, entitled “Oven.” The entirety of Chinese Patent Application No. 202222597876.1 is incorporated herein by reference.

### TECHNICAL FIELD

The present application relates to the field of ovens, more specifically, an oven for heating a member to be heated.

### BACKGROUND

Traditional ovens comprise an upper housing assembly and a lower housing assembly that form a working cavity for heating the member to be heated when the former covers the latter. The upper housing assembly is deformed when it heats the member to be heated.

### SUMMARY

Exemplary examples of the present application may address at least some of the above-described issues.

According to a first aspect of the present application, the present application provides an oven comprising a lower housing assembly, an upper housing assembly, and a retaining assembly. The upper housing assembly is disposed above the lower housing assembly, the upper housing assembly is capable of opening and closing relative to the lower housing assembly and is capable of forming a working cavity when closed with the lower housing assembly, the upper housing assembly comprises an upper housing front plate. The retaining assembly is fixedly disposed on the upper housing front plate to prevent substantial deformation of the upper housing assembly during heating.

According to the oven of the first aspect described above, when the upper housing assembly and the lower housing assembly are closed, a slit is formed between the upper housing assembly and the lower housing assembly, and the retaining assembly is capable of preventing substantial deformation of the slit when the upper housing assembly is heated.

According to the oven of the first aspect described above, the retaining assembly comprises a horizontal retaining assembly extending in the length direction of the oven and a vertical retaining assembly extending in the height direction of the oven and connected to the horizontal retaining assembly.

According to the oven of the first aspect described above, the horizontal retaining assembly comprises at least two horizontal retaining members that are disposed to be spaced apart a certain distance in the height direction and the vertical retaining assembly is disposed to be between the horizontal retaining members.

According to the oven of the first aspect described above, the vertical retaining assembly comprises at least two vertical retaining members that are disposed to be spaced apart a certain distance in the length direction.

According to the oven of the first aspect described above, the retaining assembly further comprises an oblique retaining assembly disposed to be oblique to the horizontal retaining assembly, the oblique retaining assembly comprising at least one oblique retaining member positioned between two horizontal retaining members and two vertical retaining members, and being mutually connected to the horizontal and vertical retaining assemblies.

According to the oven of the first aspect described above, the oblique retaining assembly comprises at least two oblique retaining members that are disposed to be spaced apart from the vertical retaining members, and adjacent oblique retaining members have an equal inclination angle and opposite incline relative to the horizontal retaining assembly.

According to the oven of the first aspect described above, the upper housing front plate is formed by arranging and connecting several first plates in the length direction of the oven. The horizontal retaining members are formed by arranging and connecting at least one horizontal retaining element along the length direction of the oven, and the plate connection of two adjacent first plates is disposed to be staggered in the length direction from the connection of two adjacent horizontal retaining elements.

According to the oven of the first aspect described above, the upper housing assembly further comprises an upper extending edge extending forwardly from the upper housing front plate and an upper flange extending upwardly from the upper extending edge such that an upper receiving portion is formed by the upper housing front plate, the upper extending edge and the upper flange. The bottom of at least one of the horizontal retaining members is received in the upper receiving portion.

According to the oven of the first aspect described above, the retaining assembly is formed by a metal tube or rod connection.

According to the oven of the first aspect described above, the oven further comprises at least one seal extending in the length direction of the oven and disposed at the slit between the upper housing assembly and the lower housing assembly such that the upper housing assembly and the lower housing assembly are in contact with the seal when the upper housing assembly covers the lower housing assembly.

According to the oven of the first aspect described above, the oven is a reflow oven, and the working cavity is a chamber of the reflow oven.

According to the oven of the first aspect described above, the retaining assembly is soldered on an inner side or outer side of the upper housing front plate.

According to the oven of the first aspect described above, the upper housing assembly further comprises an upper housing left plate and an upper housing right plate disposed on the two sides of the upper housing front plate, and the lower housing assembly comprises a lower housing left plate and a lower housing right plate. The working cavity has an inlet and an outlet, where the inlet is defined by the upper housing left plate and the lower housing left plate, and the outlet is defined by the upper housing right plate and the lower housing right plate.

According to the oven of the first aspect described above, the range of values for the ratio of the overall length of the retaining assembly to the length of the upper housing assembly is greater than or equal to 0.8 and less than or equal to 1.

According to the oven of the first aspect described above, the working atmosphere of the oven is nitrogen gas.

According to the oven of the first aspect described above, a first side of the upper housing assembly is in active connection with the lower housing assembly, a second side of the upper housing assembly opposite the first side is provided with the upper housing front plate.

According to a second aspect of the present application, the present application provides an oven comprising a lower housing assembly, an upper housing assembly, and a retaining assembly. The upper housing assembly is disposed above the lower housing assembly, the upper housing assembly is capable of opening and closing relative to the lower housing assembly and is capable of forming a working cavity when closed with the lower housing assembly, the upper housing assembly comprises an upper housing front plate. The retaining assembly is fixedly disposed on the upper housing front plate, the retaining assembly comprises a horizontal retaining assembly extending in the length direction of the oven and a vertical retaining assembly extending in the height direction of the oven and connected to the horizontal retaining assembly. In which, the retaining assembly is used to prevent substantial deformation of the upper housing assembly during heating.

According to the oven of the second aspect described above, when the upper housing assembly and the lower housing assembly are closed, a slit is formed between the upper housing assembly and the lower housing assembly, and the retaining assembly is capable of preventing substantial deformation of the slit when the upper housing assembly is heated.

According to the oven of the second aspect described above, the retaining assembly further comprises an oblique retaining assembly disposed to be oblique to the horizontal retaining assembly, and connected to the horizontal and vertical retaining assemblies.

The retaining assembly of the oven of the present application is disposed on the upper housing front plate, which is fixedly connected to the upper housing front plate to prevent substantial deformation of the upper housing assembly during heating. Specifically, when the upper housing front plate is heated, the retaining assembly is capable of providing a retention force for the upper housing front plate in the length and height directions to prevent the left and/or right ends of the upper extending edge of the upper housing assembly from cocking upwardly in the height direction or reducing the upward cocking distance of the left and/or right ends of the upper extending edge in the height direction such that the upper extension edge remains in contact with and/or squeezes the seal to form a sealed state on the front side of the working cavity.

### BRIEF DESCRIPTION OF THE DRAWINGS

Features and advantages of the present application may be better understood by reading the following detailed description with reference to the accompanying drawings, in which same reference numerals represent some parts throughout the accompanying drawings, where:

FIGS. 1A-1B are perspective views of the oven;

FIG. 1C is a left view of the oven shown in FIG. 1A;

FIG. 1D is a main view of the oven shown in FIG. 1A.

### DETAILED DESCRIPTION

Various specific embodiments of the present application will be described below with reference to the attached drawings that form a part of the present Specification. In the following drawings, the same parts use the same reference numerals.

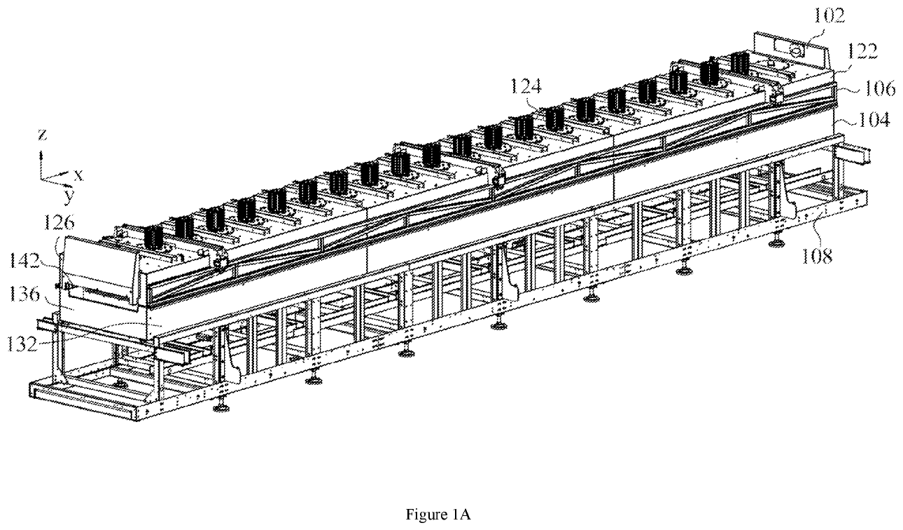

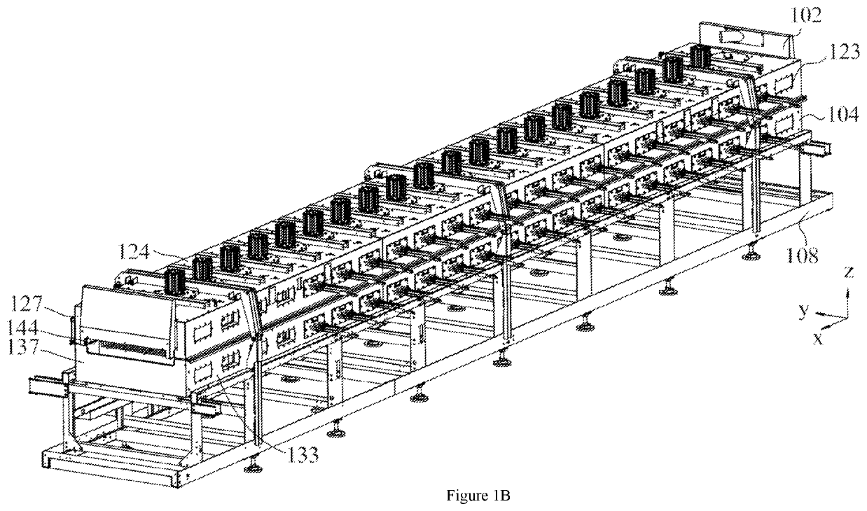

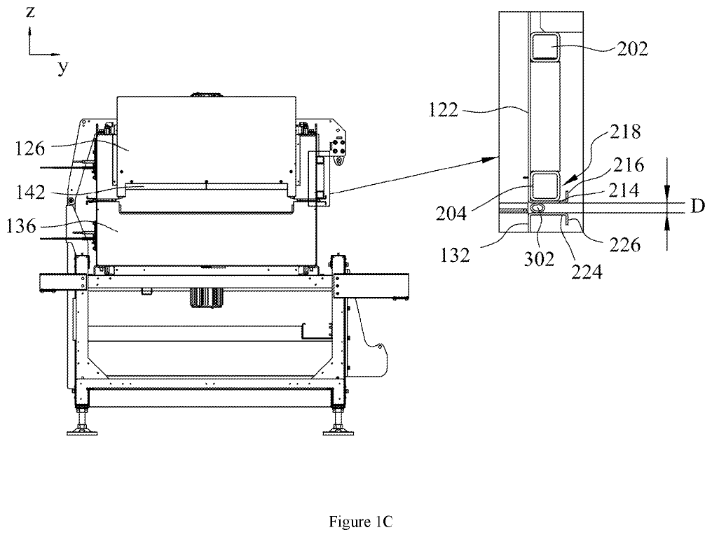

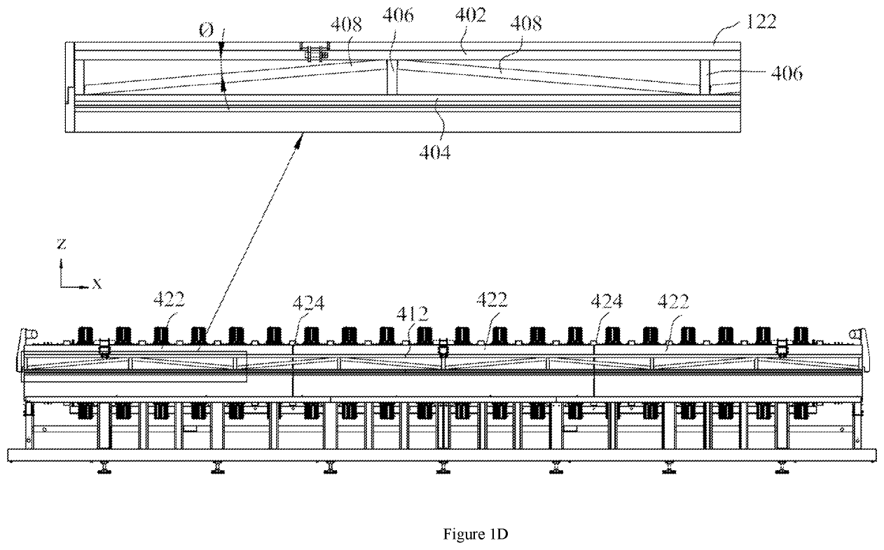

FIG. 1A is a perspective view of a first perspective of the oven of the present application to show the specific structure of the front side, left side, and top side of the oven. FIG. 1B is a perspective view of a second perspective of the oven shown in FIG. 1A to show the specific structure of the rear side, right side, and top side of the oven. FIG. 1C is a left view of the oven shown in FIG. 1A. FIG. 1D is a main view of the oven shown in FIG. 1A. As shown in FIGS. 1A-1D , the oven comprises an upper housing assembly 102 and a lower housing assembly 104. The upper housing assembly 102 and the lower housing assembly 104 extend along the length direction of the oven (i.e., the x-axis direction shown in FIG. 1A 1B), respectively. The upper housing assembly 102 is disposed above the lower housing assembly 104. The lower housing assembly 104 is fixed on the base 108. The upper housing assembly 102 is capable of opening and closing relative to the lower housing assembly 104 and is capable of forming a working cavity (not shown) when closed with the lower housing assembly 104. In an example of the present application, the rear side (i.e., the first side) of the upper housing assembly 102 is in active connection (e.g., through a hinge connection) with the rear side of the lower housing assembly 104 such that the upper housing assembly 102 is rotatable relative to the lower housing assembly 104.

Specifically, the upper housing assembly 102 comprises an upper housing upper plate 124, an upper housing front plate 122 and an upper housing rear plate 123 disposed on the front and rear sides of the upper housing upper plate 124, respectively, and an upper housing left plate 126 and upper housing right plate 127 disposed on the left and right sides of the upper housing upper plate 124, respectively. The upper housing upper plate 124, the upper housing front plate 122, the upper housing rear plate 123, the upper housing left plate 126, and the upper housing right plate 127 enclose to form an upper housing having a downward opening. An upper heating device (not shown) is provided within the enclosed cavity of the upper housing to heat the member to be heated in the working cavity. In which, the upper housing front plate 122 is disposed on the second side, which is disposed opposite the active connection (i.e., the first side) between the upper housing assembly 102 with the lower housing assembly 104.

The lower housing assembly 104 comprises a lower housing lower plate (not shown), a lower housing front plate 132 and a lower housing rear plate 133 disposed on the front and rear sides of the lower housing lower plate, respectively, and a lower housing left plate 136 and lower housing right plate 137 disposed on the left and right sides of the lower housing lower plate, respectively. The lower housing lower plate, the lower housing front plate 132, the lower housing rear plate 133, the lower housing left plate 136, and the lower housing right plate 137 enclose to form a lower housing having an upward opening. A lower heating device (not shown) is provided within the enclosed cavity of the lower housing to heat the member to be heated in the working cavity. The upper housing assembly 102 and lower housing assembly 104 form a working cavity when closed, the working cavity having an inlet 142 and an outlet 144. In which, the inlet 142 is defined by the upper housing left plate 126 and the lower housing left plate 136 and the outlet 144 is defined by the upper housing right plate 127 and lower housing right plate 137. This creates a working cavity formed along the length direction of the oven, where the inlet 142 is located on the left side and the outlet 144 is located on the right side.

As shown in FIG. 1C, the upper housing assembly 102 further comprises an upper extending edge 214 and an upper flange 216. The upper extending edge 214 extends forwardly along the width direction (i.e., y-axis direction) of the oven from the front side of the upper housing front plate 122. The upper flange 216 extends upwardly from the upper extending edge 214 along the height direction (i.e., z-axis direction) of the oven. The upper flange 216 is disposed generally parallel to the upper housing front plate 122 such that an upper receiving portion 218 is formed by the upper housing front plate 122, the upper extending edge 214, and the upper flange 216. Similarly, the lower housing assembly 104 further comprises a lower extending edge 224 and a lower flange 226. The lower extending edge 224 extends forwardly along the width direction (i.e., y-axis direction) of the oven from the front side of the lower housing front plate 132. The lower flange 226 extends downwardly from the lower extending edge 224 along the height direction (i.e., z-axis direction) of the oven. The lower flange 226 is disposed generally parallel to the lower housing front plate 132 such that a lower receiving portion is formed by the lower housing front plate 132, the lower extending edge 224, and the lower flange 226. When the upper housing assembly 102 and the lower housing assembly 104 are closed, a slit is created between the upper flange 216 and lower flange 226 (i.e., between the upper housing assembly 102 and lower housing assembly 104). In which, upper extending edge 214, the upper flange 216, the lower extending edge 224, and the lower flange 226 have the same length as the length of the upper housing assembly 102. As such, the slit has a height D on any of the cross-sections of the oven along the height direction.

FIG. 1C further shows a partial enlarged view of the components within the rectangular frame. As shown in the figure, the oven further comprises a seal 302 disposed at the slit. When the upper housing assembly 102 and lower housing assembly 104 are closed (i.e., the upper housing assembly 102 covers the lower housing assembly 104), the upper housing assembly 102 and lower housing assembly 104 are in contact with the seal 302. In an example of the present application, the seal 302 is generally an elastic member with a circular cross-section. It extends along the length direction of the oven and is disposed on the lower flange 226 of the lower housing assembly 104. When the upper housing assembly 102 covers the lower housing assembly 104, the upper flange 216 of the upper housing assembly 102 is in contact with and squeezes the seal 302, thereby deforming the seal 302 (e.g., deforming the cross-section into an oval) to seal the front side of the upper housing assembly 102 and the front side of the lower housing assembly 104.

As shown in FIGS. 1A-1D, the oven further comprises a retaining assembly 106. It is fixedly disposed on the upper housing front plate 122 to prevent substantial deformation of the upper housing front plate 122 during heating. In the present application, the retaining assembly 106 is disposed on an outer side (i.e., a front side) of the upper housing front plate 122, but it may be understood that in other examples, the retaining assembly 106 is also disposed on an inner side (i.e., a rear side of the upper housing front plate 122) of the upper housing front plate 122.

As shown in FIG. 1D, the retaining assembly 106 comprises a horizontal retaining assembly, a vertical retaining assembly, and an oblique retaining assembly. The horizontal retaining assembly extends along the length direction of the oven. The vertical retaining assembly extends along the height direction of the oven and is connected to the horizontal retaining assembly. The oblique retaining assembly is disposed to be oblique to the horizontal retaining assembly and vertical retaining assembly and is connected to the horizontal retaining assembly and vertical retaining assembly.

FIG. 1D further shows a partial enlarged view of the components within the rectangular frame. As shown, in an example of the present application, the horizontal retaining assembly comprises two horizontal retaining members, namely: a first horizontal retaining member 402 and a second horizontal retaining member 404. The first horizontal retaining member 402 and second horizontal retaining member 404 are disposed to be spaced apart a certain distance in the height direction of the oven and have the same length as the length of the upper housing assembly 102. The vertical retaining assembly and the oblique retaining assembly are disposed between the first horizontal retaining member 402 and the second horizontal retaining member 404. The vertical retaining assembly comprises nine vertical retaining members 406. The vertical retaining members 406 are disposed to be spaced apart a certain distance in the length direction of the oven. The top of the vertical retaining members 406 abuts the first horizontal retaining member 402 and is connected to the first horizontal retaining member 402. The bottom of the vertical retaining members 406 abuts the second horizontal retaining member 404 and is connected to the second horizontal retaining member 404. In which, the left-most vertical retaining member 406 is connected to the left end of the first horizontal retaining member 402 and the left end of the second horizontal retaining member 404. The right-most vertical retaining member 406 is connected to the right end of the first horizontal retaining member 402 and the right end of the second horizontal retaining member 404. The oblique retaining assembly comprises eight oblique retaining members 408. Each oblique retaining member 408 is located between the first horizontal retaining member 402, the second horizontal retaining member 404, and two adjacent vertical retaining members 406. In other words, each oblique retaining member 408 is disposed within a rectangle enclosed and formed by the first horizontal retaining member 402, the second horizontal retaining member 404, and two adjacent vertical retaining members 406. The top of the oblique retaining members 408 abuts to and is connected to the first horizontal retaining member 402 and/or the vertical retaining member 406. The bottom of the oblique retaining member 408 abuts to and is connected to the second horizontal retaining member 404 and/or the vertical retaining member 406. In other words, the oblique retaining member 408 and vertical retaining member 406 are disposed to be spaced apart between the first horizontal retaining member 402 and second horizontal retaining member 404. The two adjacent oblique retaining members 408 have an equal inclination angle o and the opposite incline relative to the first horizontal retaining member 402 and second horizontal retaining member 404.

With reference to FIG. 1C, in an example of the present application, the retaining assembly 106 is formed by a metal square tube connection. The bottom of the second horizontal retaining member 404 of the retaining assembly 106 is received in the upper receiving portion 218 such that the bottom of the retaining assembly 106 is disposed proximate to the upper extending edge 214.

Referring to FIG. 1D, in an example of the present application, the horizontal retaining members (e.g., the first horizontal retaining member 402 and second horizontal retaining member 404) are formed by arranging and connecting two horizontal retaining elements along the length direction of the oven, which are connected at connection 412. The upper housing front plate 122 is formed by arranging and connecting three first plates 422 along the length direction of the oven, which are connected at the plate connection 424. In the length direction of the oven, the connection 412 is disposed to be staggered from the plate connection 424 such that the connection performance of the retaining assembly 106 is improved in the length direction. As an example, the oven is about 8 m in length and each horizontal retaining element is about 4 m in length.

It must be noted that although the retaining assembly 106 is formed from a metal square tube connection in an example of the present application, in some examples, the retaining assembly 106 may be formed from a metal tube connection of any cross-sectional shape. Further, in some other examples, the retaining assembly 106 may be formed from a metal rod connection of any cross-sectional shape. As an example, the various components in the retaining assembly 106 are connected by soldering, then connected to the upper housing front plate 122 by soldering.

It must also be noted that while a specific number of the horizontal retaining assembly, the vertical retaining assembly, and the oblique retaining assembly are shown in an example of the present application, in other examples, the horizontal retaining assembly comprising at least two horizontal retaining elements, the vertical retaining assembly comprising at least two vertical retaining members, and/or the oblique retaining assembly comprising at least one oblique retaining member are within the scope of protection of the present application.

It must also be noted that while the overall length of the retaining assembly 106 (i.e., the extending length of the left and right ends of the entire retaining assembly 106 in the length direction of the oven) is the same as the length of the upper housing assembly 102 in an example of the present application, in other examples, the range of values of the overall length of the retaining assembly 106 to the length of the upper housing assembly 102 is greater than or equal to 0.8 and less than or equal to 1. As an example, the retaining assembly 106 is disposed centrally relative to the upper housing assembly 102.

It must also be noted that although the seal 302 extends along the length direction of the oven and is an integrally molded seal (e.g., integrally molded by molding or integrally molded by foaming) in an example of the present application, in other examples, the seal 302 may be formed by the at least two sealing elements connected along the length direction of the oven. Further, although only one seal 302 is provided at the slit between the upper housing assembly 102 and the lower housing assembly 104 in an example of the present application, in other examples the slit at which at least two seals 302 are arranged in parallel along the width direction of the oven is also within the scope of protection of the present application.

In conventional ovens, the inventors have discovered that the upper housing assembly 102 is heated when the oven is running (i.e., the member to be heated is heated), resulting in substantial deformation. In which, the term “substantial deformation” refers to the left end and/or right end of the upper extending edge 214 of the upper housing assembly 102 cocking upwardly along the height direction, and is unable to form a sealed state with the front side of the working cavity with the seal 302.

In the oven of the present application, the retaining assembly 106 is disposed on the upper housing front plate 122 and is fixedly connected to the upper housing front plate 122 to prevent substantial deformation of the upper housing assembly 102 during heating. Specifically, when the upper housing front plate 122 is heated, the retaining assembly 106 is capable of providing a retention force for the upper housing front plate 122 in the length and height directions to prevent the left and/or right ends of the upper extending edge 214 of the upper housing assembly 102 from cocking upwardly in the height direction or reducing the upward cocking distance of the left and/or right ends of the upper extending edge 214 in the height direction such that the upper extension edge 214 remains in contact with and/or squeezes the seal 302 to form a sealed state on the front side of the working cavity.

As an example, the oven in the present application is a reflow oven. The above working cavity is a chamber of the reflow oven. The chamber of the reflow oven comprises a preheating zone, a heating zone, and a cooling zone disposed along the length direction of the oven. In which, the preheating zone is used to preheat the member to be heated. The heating zone is used to heat the member to be heated. The cooling zone is used to cool the member to be heated. As an example, the heating temperature of the heating zone is 250° C.-280°C. When the oven is not running (e.g., when the temperature of the oven is ambient temperature), in the height direction, the distance D between the left end of the upper extending edge 214 and the left end of the lower extending edge 224 is 5 mm, and the upper extending edge 214 and lower extending edge 224 are able to be in contact with and/or squeeze the seal 302. When the oven is running, the upper housing assembly 102 is heated, the distance D between the left end of the extending edge 214 and the left end of the lower extending edge 224 is 8 mm in the height direction, and the upper extending edge 214 and lower extending edge 224 are able to be in contact with and/or squeeze the seal 302 to form a sealed state on the front side of the chamber. As such, the retaining assembly 106 is capable of ensuring a sealed state on the front side of the chamber, thereby maintaining the heating temperature in the chamber.

As another example, the working atmosphere of the oven is nitrogen gas. The retaining assembly 106 is capable of ensuring a sealed state on the front side of the chamber, thereby preventing nitrogen gas spillage.

It must be noted that in existing ovens, the retaining assembly 106 of the present application is able to prevent substantial deformation of the upper housing assembly 102 during heating. Further, the retaining assembly 106 of the present application has a good retention effect for ovens having a large length-height ratio (e.g., the length to height ratio of the oven is greater than 10). In other words, the length of the chamber of the oven having a retaining assembly 106 may be extended. After the extension, the oven is still capable of having good sealing performance.

Although the present disclosure has been described in conjunction with the examples of examples outlined above, various alternatives, modifications, variations, improvements, and/or substantial equivalents, whether known or foreseeable now or in the near future, may be apparent to those having at least ordinary skill in the art. In addition, the technical effects and/or technical problems described in the present Specification are exemplary and not limiting; therefore, the disclosure in the present Specification may be used to solve other technical problems and have other technical effects and/or may solve other technical problems. Therefore, the examples of examples of the present disclosure as set forth above are intended to be illustrative and not limiting. Various changes may be made without departing from the spirit or scope of the present disclosure. Therefore, the present disclosure is intended to include all known or earlier developed alternatives, modifications, variations, improvements and/or substantial equivalents.

1. An oven, comprising:
a lower housing assembly;
an upper housing assembly, disposed above the lower housing assembly, the upper housing assembly being capable of opening and closing relative to the lower housing assembly, being capable of forming a working cavity when closed with the lower housing assembly, and comprising an upper housing front plate; and
a retaining assembly, being fixedly disposed on the upper housing front plate to prevent substantial deformation of the upper housing assembly during heating.

2. The oven according to claim 1 wherein, when the upper housing assembly and the lower housing assembly are closed, a slit is formed between the upper housing assembly and the lower housing assembly, and the retaining assembly is capable of preventing substantial deformation of the slit when the upper housing assembly is heated.

3. The oven according to claim 1, wherein the retaining assembly comprises a horizontal retaining assembly and a vertical retaining assembly, the horizontal retaining assembly is disposed along the length direction of the oven, and the vertical retaining assembly is disposed along the height direction of the oven and connected to the horizontal retaining assembly.

4. The oven according to claim 3, wherein the horizontal retaining assembly comprises at least two horizontal retaining members that are disposed to be spaced apart a certain distance in the height direction and the vertical retaining assembly is disposed to be between the horizontal retaining members.

5. The oven according to claim 4, wherein the vertical retaining assembly comprises at least two vertical retaining members that are disposed to be spaced apart a certain distance in the length direction.

6. The oven according to claim 5, wherein the retaining assembly further comprises an oblique retaining assembly disposed to be oblique to the horizontal retaining assembly, the oblique retaining assembly comprising at least one oblique retaining member positioned between two horizontal retaining members and two vertical retaining assemblies, and being mutually connected to the horizontal and vertical retaining assemblies.

7. The oven according to claim 6, wherein the oblique retaining assembly comprises at least two oblique retaining members that are disposed to be spaced apart from the vertical retaining members, and adjacent oblique retaining members have an equal inclination angle and opposite incline relative to the horizontal retaining assembly.

8. The oven according to claim 4, wherein the upper housing front plate is formed by arranging and connecting several first plates along the length distance of the oven,
the horizontal retaining members are formed by arranging and connecting at least one horizontal retaining element along the length direction of the oven, and
the plate connection of two adjacent first plates is disposed to be staggered in the length direction from the connection of two adjacent horizontal retaining elements.

9. The oven according to claim 4, wherein the upper housing assembly further comprises an upper extending edge extending forwardly from the upper housing front plate and an upper flange extending upwardly from the upper extending edge such that an upper receiving portion is formed by the upper housing front plate, the upper extending edge and the upper flange, wherein the bottom of at least one of the horizontal retaining members is received in the upper receiving portion.

10. The oven according to claim 1, wherein the retaining assembly is formed by a metal tube or rod connection.

11. The oven according to claim 2, further comprising at least one seal extending along the length direction of the oven and disposed at the slit between the upper housing assembly and the lower housing assembly, such that the upper housing assembly and the lower housing assembly are in contact with the seal when the upper housing assembly covers the lower housing assembly.

12. The oven according to claim 1, wherein the oven is a reflow oven, and the working cavity is a chamber of the reflow oven.

13. The oven according to claim 1, wherein the retaining assembly is soldered to an inner side or outer side of the upper housing front plate.

14. The oven according to claim 1, wherein:
the upper housing assembly further comprises an upper housing left plate and an upper housing right plate disposed on the two sides of the upper housing front plate, the lower housing assembly comprises a lower housing left plate and a lower housing right plate;
the working cavity has an inlet defined by the upper housing left plate and the lower housing left plate and an outlet defined by the upper housing right plate and the lower housing right plate.

15. The oven according to claim 1, wherein the range of values of the overall length of the retaining assembly to the length of the upper housing assembly is greater than or equal to 0.8 and less than or equal to 1.

16. The oven according to claim 1, wherein the working atmosphere of the oven is nitrogen gas.

17. The oven according to claim 1, wherein a first side of the upper housing assembly is in active connection with the lower housing assembly, and a second side of the upper housing assembly opposite the first side is provided with the upper housing front plate.

18. An oven, comprising:
a lower housing assembly;
an upper housing assembly, disposed above the lower housing assembly, the upper housing assembly being capable of opening and closing relative to the lower housing assembly, being capable of forming a working cavity when closed with the lower housing assembly, and comprising an upper housing front plate; and
a retaining assembly, fixedly disposed on the upper housing front plate, the retaining assembly comprises a horizontal retaining assembly extending along the length direction of the oven and a vertical retaining assembly extending along the height direction of the oven and connected to the horizontal retaining assembly;
in which, the retaining assembly is used to prevent substantial deformation of the upper housing assembly during heating.

19. The oven according to claim 18 wherein, when the upper housing assembly and the lower housing assembly are closed, a slit is formed between the upper housing assembly and the lower housing assembly, and the retaining assembly is capable of preventing substantial deformation of the slit when the upper housing assembly is heated.

20. The oven according to claim 18, wherein the retaining assembly further comprises an oblique retaining assembly disposed to be oblique to the horizontal retaining assembly, and connected to the horizontal and vertical retaining assemblies.
